(19) United States
(12) Patent Application Publication
(10) Pub. No.: US 2025/0093819 A1
(43) Pub. Date: Mar. 20, 2025

(54) MECHANISM FOR ADJUSTING THE ENDSHAKE OF A TIMEPIECE MOBILE UNIT FOR A TIMEPIECE

(71) Applicant: ROLEX SA, Geneva (CH)

(72) Inventor: Julien Cattaneo, Esery (FR)

(73) Assignee: ROLEX SA, Geneva (CH)

(21) Appl. No.: 18/889,304

(22) Filed: Sep. 18, 2024

(30) Foreign Application Priority Data
Sep. 19, 2023 (EP) 23198289.3

(51) Int. Cl. G04B 31/00

(52) U.S. Cl. CPC G04B 31/00

(57) ABSTRACT

The mechanism (20) for adjusting the endshake of a timepiece mobile unit (40) for a timepiece (300) includes: an axis (D), a first component (1), a second component (2) intended to receive or to form at least one bearing (15), interface elements (4) collaborating with the first and second components, a return element (8) returning the first and second components into collaboration with the interface elements (4), and at least first shaped portions (6, 5, 3.1) of the first and second components collaborating with the interface elements (4) to move the interface elements (4) relative to the axis (D) in a plane (P) perpendicular or near-perpendicular to the axis (D) and thus move the second component (2) translationally along the axis (D) relative to the first component (1) under the effect of a rotational movement about the axis (D) of the first component (1) or of the second component (2).

### CROSS-REFERENCE TO RELATED APPLICATION

This application claims priority of European patent application No. EP23198289.3 filed Sep. 19, 2023, the content of which is hereby incorporated by reference herein in its entirety.

### FIELD OF THE INVENTION

The invention relates to a mechanism for adjusting the endshake of a timepiece mobile unit for a timepiece. The invention also relates to an assembled bearing, notably an assembled damping bearing, comprising such a mechanism. The invention also relates to a mounted movement blank comprising such an assembled bearing or such a mechanism. The invention also relates to an assembly comprising such an assembled bearing or such a mechanism or such a mounted movement blank. The invention further relates to a timepiece movement comprising such an assembly or such an assembled bearing or such a mechanism or such a mounted movement blank. The invention also relates to a timepiece comprising such a timepiece movement or such an assembly or such an assembled bearing or such a mechanism or such a mounted movement blank. The invention finally relates to a method for adjusting the endshake of a timepiece mobile unit of such a timepiece movement or of such a timepiece.

### BACKGROUND ART

In the prior art of mechanisms for adjusting the endshake of the mobile unit for a timepiece, CH714809 proposes a device for adjusting the balance wheel endshake comprising an intermediate bearing element positioned between a stud support and a shock-absorbing damping bearing. That element comprises a through-hole designed to allow the shock-absorbing damping bearing to be driven into it. The endshake is then adjusted by moving the shock-absorbing damping bearing along the hole in the intermediate bearing element, and the damping bearing is held therein through the effect of friction.

Patent EP2824518 proposes a device for the micrometric adjustment of the endshake of a mobile unit. The adjusting device comprises an endstone bearing and a bearing body made up of various elements:
an outer body comprising a central bore, rims standing up on its interior-face side, and indexing means on its interior face, of the notch or boss type, and
three elements stacked inside the outer body.

The three stacked elements comprise:
an elastic-return element, fixed to a bearing support and comprising elastic tabs that anchor into the indexing means in order to introduce discrete adjustment positions,
a bearing support comprising at least a first evolving contact surface, which is to say one the thickness of which varies in the axial direction and about the axis,
a cover, secured to the upper edge of the exterior body and comprising at least a second evolving contact surface which collaborates with the first evolving contact surface.

Rotating the bearing support about the axis varies the axial position of the bearing as a result of the collaboration of the surfaces. In order to allow the bearing support to be rotated, it comprises a rotation means of the screwdriver socket type. The torque that holds the elastic-return element in the indexing means is low enough that the bearing support can be made to rotate when pivoted by a horologist, and high enough that it maintains its position when the mobile unit or the balance is in operation.

It is thus possible to incorporate a timepiece mobile unit endshake adjusting system directly into a bearing, around the axis of the mobile unit, using the effect of friction, as proposed by patent CH714809. Nevertheless, this device is somewhat imprecise for micrometric adjustment.

Patent EP2824518 on the other hand proposes a mechanism for adjusting the endshake of a timepiece mobile unit directly about the axis of the timepiece mobile unit by converting a rotary movement of a bearing support, which movement is brought about by a horologist, into a movement of axial translation of the shock-absorbing damper, this being achieved by means of a movement-conversion device that notably employs a helicoidal slide connection. That solution proposes direct contact between evolving surfaces, and gives rise to a number of notable disadvantages, such as:
discontinuous adjustment of the endshake such that there is some finite increment between two discrete indexing positions;
complex manufacture, with evolving surfaces of a shape/a mating shape that are difficult to control and to reproduce, particularly to the required tolerances;
sensitivity to shocks. Indeed, the elastic-return element holds the bearing body in a position of equilibrium thanks to anchoring, which stresses the elastic return permanently. Because of the helicoidal slide connection, the tangential force resulting from an axial shock may generate a non-negligeable misadjustment torque, hence the need to anchor the return element in discrete positions.

### SUMMARY OF THE INVENTION

The objective of the invention is to provide a endshake adjusting mechanism able to improve on the mechanisms known from the prior art.

In particular, the invention proposes a endshake adjusting mechanism that is simple, practical to use and reliable, enabling a horologist to make a fine, easy and repeatable adjustment to the endshake, through use of a movement-conversion device.

According to the invention, an adjusting mechanism is defined by point 1 below.

1. A mechanism for adjusting the endshake of a timepiece mobile unit for a timepiece, the mechanism comprising:
an axis,
a first component,
a second component intended to receive or to form at least one bearing, notably at least one damping bearing,
interface elements collaborating with the first and second components,
a return element returning the first and second components into collaboration with the interface elements, and
at least first shaped portions of the first and second components which collaborate with the interface elements in order to move said interface elements relative to the axis in a plane perpendicular or near-perpendicular to said axis and thus move the second component translationally along said axis relative to the first component under the effect of a rotational movement about said axis of the first component or of the second component.

Embodiments of the endshake adjusting mechanism are defined by points 2 to 9 below.

2. The mechanism as defined in the preceding point, wherein the interface elements take the form of rolling and/or sliding elements, notably in the form of balls, particularly in the form of three or four rolling and/or sliding elements, particularly in the form of three or four balls.

3. The mechanism as defined in one of the preceding points, wherein the first component or the second component comprises at least second shaped portions to allow relative movement of the first component and of the second component in rotation about the axis.

4. The mechanism as defined in one of the preceding points, wherein the first component or the second component comprises, by way of first shaped portion, at least a first path specific to each interface element, notably at least a first groove intended to collaborate with an interface element, particularly three or four paths equally distributed about the axis, notably three or four first grooves equally distributed about the axis.

5. The mechanism as defined in the preceding point, wherein the at least one first path defines a pathway in the form of a spiral around the axis, or a pathway that is substantially orthoradial with respect to the axis.

6. The mechanism as defined in point 4 or 5, wherein the first component or the second component, distinct from the component comprising the at least one first path, comprises, by way of first shaped portion, at least one second groove intended to collaborate with an interface element and extending in a direction that is radial or near-radial relative to the axis and in particular comprises three or four grooves extending in a direction that is radial or near-radial relative to the axis and equally distributed about the axis.

7. The mechanism as defined in the preceding point, wherein the at least one second groove is formed on a washer that rotates as one with the first component or the second component distinct from the component comprising the at least one first path.

8. The mechanism as defined in one of the preceding points, wherein the first component or the second component comprises, by way of first shaped portion, a conical or frustoconical surface intended to collaborate with the interface elements.

9. The mechanism as defined in one of the preceding points, wherein the first and second components fit one into the other, the second component notably fitting into the first component.

According to the invention, an assembled bearing is defined by point 10 below.

10. An assembled bearing, notably an assembled damping bearing, comprising a mechanism as defined in one of the preceding points.

According to the invention, a mounted movement blank is defined by point 11 below.

11. A mounted movement blank, notably a mounted bridge, comprising a mechanism as defined in one of points 1 to 10 and/or a bearing as defined in the preceding point.

According to the invention, an assembly is defined by point 12 below.

12. An assembly comprising:
a bearing, notably a damping bearing,
a movement blank, and
a mechanism as defined in one of points 1 to 9 arranged at the interface between the bearing and the movement blank.

According to the invention, a timepiece movement is defined by point 13 below.

13. A timepiece movement comprising:
a mechanism as defined in one of points 1 to 9, and/or
a bearing as defined in point 10, and/or
a mounted movement blank as defined in point 11, and/or
an assembly as defined in the preceding point, and
a mobile unit, notably an assembled balance.

According to the invention, a timepiece is defined by point 14 below.

14. A timepiece, notably a wristwatch, comprising:
a movement as defined in the preceding point, and/or
a mechanism as defined in one of points 1 to 9, and/or
a bearing as defined in point 10, and/or
a movement blank as defined in point 11, and/or
an assembly as defined in point 12.

According to the invention, an adjusting method is defined by point 15 below.

15. A method for adjusting the endshake of a timepiece mobile unit of a timepiece movement as defined in point 13 or of a timepiece as defined in the preceding point, the method comprising:
an action of moving one component in rotation about the axis relative to the other component.

### BRIEF DESCRIPTION OF THE DRAWINGS

The appended drawings depict, by way of examples, two embodiments of a timepiece according to the invention.

FIG. 1 is a view in cross section and in perspective of one particular embodiment of a timepiece according to the invention including one particular embodiment of a endshake adjusting mechanism, in a first configuration.

FIG. 2 is a view in cross section and in perspective of the particular embodiment of the endshake adjusting mechanism, in a second configuration.

FIG. 3 is a view in cross section of the particular embodiment of the endshake adjusting mechanism in the first configuration.

FIG. 4 is a view in cross section of the particular embodiment of the endshake adjusting mechanism, in the second configuration.

FIG. 5 is an exploded and perspective view of the particular embodiment of the endshake adjusting mechanism.

FIG. 6 is a perspective view of one embodiment of a mounted movement blank including the particular embodiment of the endshake adjusting mechanism.

FIG. 7 is a view in cross section of the embodiment of the mounted movement blank of FIG. 6.

FIG. 8 is a view of an alternative embodiment of a timepiece according to the invention, including an alternative embodiment of a endshake adjusting mechanism.

### DETAILED DESCRIPTION OF PARTICULAR EMBODIMENTS

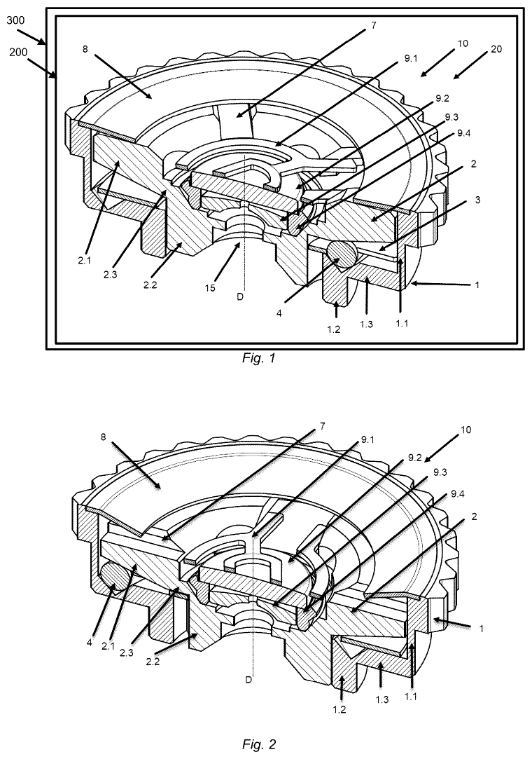

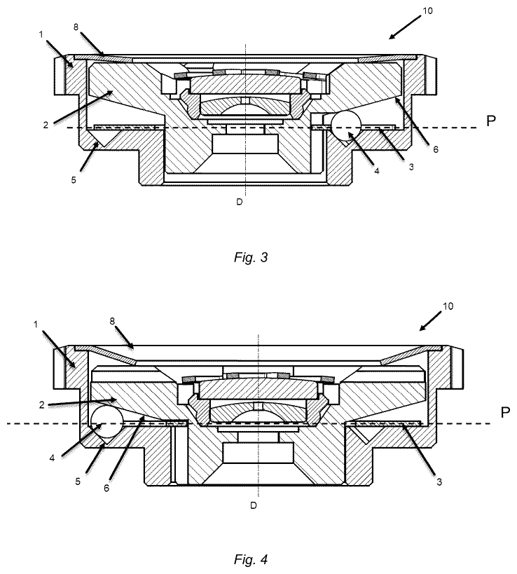

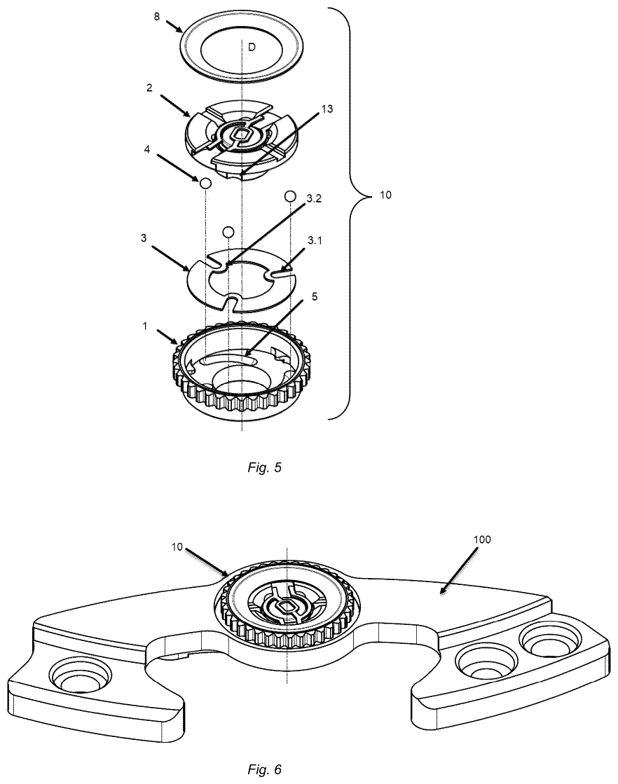

One particular embodiment of a timepiece 300 is described in detail with reference to FIGS. 1 to 7.

The timepiece 300 is for example a watch, in particular a wristwatch. The timepiece 300 comprises a timepiece movement 200 intended to be mounted in a timepiece casing or case in order to protect it from the external environment.

The timepiece movement 200 is a mechanical movement, notably an automatic movement, or a hybrid movement, or an electronic movement.

The timepiece movement 200 comprises:
an assembled bearing 10, notably an assembled damping bearing, comprising a endshake adjusting mechanism 20, and/or
a mounted movement blank 100, notably a mounted bridge 100, comprising a endshake adjusting mechanism 20, and/or
an assembly comprising a bearing 15, notably a damping bearing, a movement blank and a endshake adjusting mechanism 20.

The endshake adjusting mechanism may be installed at an interface between the bearing and a movement blank so as to allow relative movement of the bearing relative to the movement blank. Consequently, part of the endshake adjusting mechanism may form part of the bearing 15 and/or part of the endshake adjusting mechanism may form part of the movement blank.

In all cases, the timepiece movement comprises the endshake adjusting mechanism 20.

The endshake adjusting mechanism 20 makes it possible to adjust the endshake of a timepiece mobile unit 40 of the timepiece movement 200 relative to a case of the timepiece movement 200. The endshake is adjusted by moving at least one bearing element of the bearing that guides the timepiece mobile unit relative to the case of the timepiece movement. The timepiece mobile unit is advantageously an assembled balance wheel, but could also be of any other kind. The balance endshake, which is to say the functional axial clearance between the balance staff pivots and the endstone jewels, is of the same order of magnitude as the dimensional manufacturing tolerances on the elements of the adjusting member. The possibility to adjust this endshake is therefore essential in order to ensure correct operation of the balance wheel and maintain good timekeeping of the timepiece. In particular, the invention makes endshake adjustment possible by rotating a portion of the adjusting mechanism 20.

According to the particular embodiment described in detail hereinbelow with reference to FIGS. 1 to 7, the endshake adjusting mechanism comprises:
an axis D,
a first component 1, particularly a first component 1 intended to be secured to a movement blank of the timepiece movement,
a second component 2 intended to receive or to form at least one bearing 15, notably at least one damping bearing,
three interface elements 4 collaborating with the first and second components,
a return element 8 returning the first and second components into collaboration with the three interface elements 4, and
first shaped portions 6, 5, 3.1 of the first and second components which collaborate with the three interface elements 4 in order to move these three interface elements 4 relative to the axis D in a plane P perpendicular or near-perpendicular to said axis D and thus move the second component 2 translationally along said axis D relative to the first component 1 under the effect of a rotational movement about said axis D of the second component 2.

The timepiece mobile unit 40 is preferably guided in its rotation or its pivoting about the axis D by the at least one bearing 15.

Advantageously, the adjusting mechanism enables a rotational movement (performed by a horologist) of the second component relative to the first component into a movement of axial translation of a bearing element.

When the endshake is being adjusted, the rotation of the second component 2 relative to the first component 1 causes, on account of the shaped portions 5 and 3.1, the interface elements 4 to move in a plane P perpendicular or near-perpendicular to said axis D. In particular, the interface elements move away from or toward the axis D in a plane perpendicular or near-perpendicular to said axis D. The combination of the return element 8 and of the shaped portion 6 which has an evolving surface, evolving about said axis D, in contact with the interface elements 4 enables precise translational movement of the second component 2 along said axis D relative to the first component 1.

According to the particular embodiment described in detail hereinafter with reference to FIGS. 1 to 7, the interface elements advantageously take the form of balls and are three in number. These balls are interposed between the two components and are intended to collaborate with the two components. The interactions between the three balls and the two elements make it possible, when the first component 1 starts to rotate (for a rotation torque higher than the friction torque induced by the spring 8 at the interfaces between the first component 1, the three balls 4 and the second component 2) to bring about an axial translational movement of the second component 2 and therefore of the bearing.

In this particular embodiment, the second component 2 bears or takes the form of a damping bearing 15, particularly a balance wheel damping bearing, notably provided with an in-setting 9.4, with an endstone jewel 9.2, with a bored jewel 9.3 and with a lyre-shaped spring clip 9.1. The bearing 15 forms, with the endshake adjusting mechanism 20, an assembled bearing 10. In this particular embodiment, the component 2 is part of both the bearing 15 and the endshake adjusting mechanism 20.

In one particular variant, the second component 2 and the setting 9.4 could consist of one single piece.

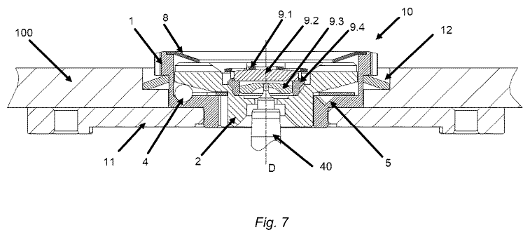

The first component 1 of the assembled bearing 10 is advantageously secured to a timepiece movement blank 100, notably to a balance bridge 100, particularly a traversing balance bridge 100, a balance cock or the like. In the particular embodiment more particularly illustrated in FIG. 7, the first component is secured to the movement blank 100 while having a degree of freedom to rotate about the axis D. In particular, the first component is advantageously driven into a hairspring support 11 arranged beneath the bridge 100. The first component 1 may be held secured to the bridge 100 by a spring-loaded element 12 which presses both against the upper face of the bridge 100 and against the exterior surface of the ring 1.1 of the first component 1. Rotating the first component 1 then allows adjustment of the guide-mark setting (of an escapement collaborating with an oscillator of which the balance forms part) without disturbing the setting to which the endshake has been adjusted.

As a variant, the first component 1 could be fixed to or embedded in the movement blank 100, which is to say exhibit no degree of freedom with respect to the movement blank 100. In another variant, the first component 1 and the movement blank could form just one single piece. In other words, in such a variant, the first component consists of the movement blank.

According to the particular embodiment described in detail hereinafter with reference to FIGS. 1 to 7, the first component 1 comprises first shaped portions 5, preferably in the form of cams, with which the interface elements 4 come into contact. The second component 2 comprises a conical or frustoconical or near-frustoconical circumferential surface 6 with which the interface elements 4 are in contact. By altering:
the geometries of the contact surfaces of the shaped portions 5, 3.1, and/or
the geometry of the circumferential surface 6, and/or
the geometry of the interface elements 4, and/or
the number of interface elements 4 and the geometries thereof, it is possible, by rotating the second component 2, to bring about precise variations in the axial (along the axis D) location of the second component 2, and therefore of the bearing, relative to the first component 1.

In the adjusting mechanism, rotating the second component 2 with respect to the first component 1 causes the interface elements 4 to move with a radial component of movement along the respective shaped portions 5, 3.1. This movement changes the position of the bearing points at which the interface elements 4 press against the external circumferential surface 6 and causes axial translation (along the axis D) of the second component 2 relative to the first component 1.

The return element 8, secured to the upper edge of the first component 1, presses elastically against the upper edge of the second component 2. It exerts enough pressure on the second component 2 and the interface elements 4 against the first component 1 to cancel any play there might be and ensure that the components 1, 2 and 4 are kept in slip-free contact, except during the adjustment phase.

In this particular embodiment, the assembled bearing that allows the mobile unit to pivot about the axis D is made up of various elements:
the first component 1, intended to be secured to the movement blank of the timepiece movement;
the second component 2 intended to receive or to form at least one bearing;
the three interface elements consisting for example of balls 4, held in position by an interposed washer 3;
the return element 8, secured to an upper edge of the first component 1, pressing elastically against the upper edge of the second component 2, and returning the first and second components into collaboration with the balls 4. In particular, the return element 8 has the form of a frustoconical elastic washer.

In this particular embodiment, the interposed washer 3 rotates as one with the second component 2 and comprises, by way of shaped portions, second grooves (or second paths) 3.1 each intended to receive one ball 4. These second grooves 3.1 are of use in controlling the radial movement, with respect to the axis D, of the balls 4 in the plane P and, in particular, the movement of said balls along their shaped portion 5. In particular, this interposed washer 3 comprises as many second grooves 3.1 as there are balls 4, in this instance three. These second grooves 3.1 form guides or paths that are open-ended and pass all the way through, so as to allow the balls the possibility of moving over the entire extent of their respective path. In this embodiment, the first component 1 is a part made up of a ring 1.1 connected to a hub 1.2. This hub 1.2 is centered on the same axis D as the ring 1.1 and has outside and inside diameters that are respectively smaller than those of the ring 1.1, so that a connecting element 1.3 connects the top of the outside circumference of the hub 1.2 to the bottom of the inside circumference of the ring 1.1. The connecting portion 1.3 here makes an angle of 90 degrees with respect to the axis D, which is to say that it extends substantially radially relative to the axis D. Hollowed into the internal surface of the connection are three first grooves 5 of equal depths which form first paths 5 or shaped portions 5.

The first grooves 5 define a shape or pathway that is curved or in the form of a spiral around the axis D, or a shape or a pathway that is rectilinear, being substantially orthoradial with respect to the axis D. The angle formed between the tangent to said pathway and a straight line passing through the axis D and intersecting said tangent makes an oblique angle, namely an angle different than 90°. The first grooves 5 are preferably equally distributed about the axis D of the first component 1.

In a variant, the surface of the connecting portion 1.3 could be slightly convex or could make an angle slightly different than 90 degrees with respect to the axis D, in order for example to facilitate for example the initial positioning of the balls 4 in the first grooves 5 during assembly of the bearing.

In this embodiment, the second component 2 is a part made up of a ring 2.1 connected to a hub 2.2 which is centered on the same axis and has outside and inside diameters that are smaller than those of the ring 2.1 and that has a connecting portion 2.3 connecting the two elements 2.1, 2.2. The outside diameters of the ring 2.1 and of the hub 2.2 of the second component 2 correspond, disregarding clearances, respectively to the inside diameters of the ring 1.1 and of the hub 1.2 of the first component 1, so that the two elements fit one inside the other. The exterior surface of the connecting portion 2.3 of the second component 2, more specifically the surface extending between the hub 2.2 and the outside circumference of the ring 2.1, constitutes the external circumferential surface 6 and notably has a frustoconical or near-frustoconical shape.

Rotating the second component 2 about said axis D causes, through the effect of the associated interposed washer 3, the balls 4 to move radially along their respective groove 5. This movement changes the position of the bearing points at which the balls 4 press against the external circumferential surface 6 and causes axial translation (along the axis D) of the second component 2 along the first component 1.

The return element 8, secured to the upper edge of the first component 1, presses elastically against the upper edge of the second component 2 and exerts enough pressure on the second component 2 and the balls 4 against the first component 1 to cancel any play there might be and ensure that the components 1, 2 and 4 are kept in slip-free contact, except during the adjustment phase.

Advantageously, the positioning of the three balls 4 forms a regular polygon centered on the axis D where each ball is situated at a vertex of the polygon. The balls thus provide the seating of the component 2 on the component 1, this seating preferably being statically determinate.

According to a preferred embodiment, the interposed washer 3 rotates as one with the hub 2.2 of the second component 2 with at least one degree of freedom in axial translation along the hub 2.2, which is to say that the interposed washer 3 is mounted with a slide connection of axis D relative to the hub 2.2 of the second component 2. In order to achieve this, a tab 3.2 of the interposed washer 3 may be lodged in an axial groove 13 provided in the hub 2.2. When the second component 2 is turned, the interposed washer 3 pushes the balls along the first grooves 5 so as to allow the second component 2 an axial translation (along the axis D) along the first component 1.

In order to allow the horologist to rotate the second component 2, at least second shaped portions 7, such as, for example, a screwdriver socket, may be present on the upper part of the second component 2. The return element may in this embodiment be holed at its center in order to permit access to the at least second shaped portions 7. This holing may be substantial in the case of a timepiece shock-absorbing damping bearing in order also to allow the removal of the lyre-shaped spring clip 9.1 for example.

At least one guide mark, such as splines on the outside circumference of the first component 1 for example, may enable the horologist to visualize the angle through which to rotate the second component 2 when performing the rotating. These splines may also be used to allow a better grip on the first component 1 and assist with rotating it about the axis D when adjusting a guide mark setting of an escapement without disturbing the setting to which the endshake has been adjusted.

It is advantageous to note that the endshake adjusting mechanism is somewhat insensitive to shocks. Specifically, due to the shaped portion of the endshake adjusting mechanism, the (essentially axial or radial) forces to which the bearing is liable to be subjected have no impact on the movement of the interface elements 4 and therefore on the endshake adjustment. For example, by virtue of the movement-conversion device, the tangential force that results from an axial force during a shock and that is liable to generate an adjustment-disturbing torque, is negligible in comparison with the friction (or friction torque) generated by the return element 8.

Thus, in the particular embodiment described, the assembled bearing comprises:
the first component 1, secured to the bridge 100;
the second component 2, which fits into the first component 1;
three balls 4, held in position by an interposed washer 3;
the interposed washer 3, which comprises second grooves 3.1 which are radial relative to the axis D and intended for positioning the balls 4;
the return element 8, secured to the upper edge of the first component 1, pressing elastically against the upper edge of the second component 2, and in the form of a washer.

The first component 1 comprises, by way of shaped portions, three first paths of the groove type 5, which are curved and equally distributed about the axis D. The interposed washer 3 has a central hole which conforms to the exterior shape of the hub 2.2 of the second component 2, thus securing said interposed washer 3 and the second component 2 to one another such that they will rotate as one. The interposed washer 3 is inserted and rests on the interior face of the first component 1 so that its second grooves 3.1 intersect the grooves 5 of the first component 1. The balls are placed in their respective groove 5 of the first component 1 inside paths 3.1 of the interposed washer, which paths are formed by the second grooves 3.1.

The second component 2 is installed by sliding along the axis D. It bears the assembly comprising the setting 9.4, the holed jewel 9.3, the endstone jewel 9.2 and the lyre-shaped spring clip 9.1 on the inside of its central housing. The second component 2 also comprises at least second shaped portions 7, of the screw socket type, enabling it to be rotated. The surface 6 between its hub 2.2 and the circumference of its ring 2.1 is frustoconical in shape with the cone vertex at the hub 2.2.

The return element 8, secured to the upper edge of the first component 1 and pressing elastically against the upper edge of the second component 2, exerts, on the assembly made up of the second component 2 and of the balls 4, enough pressure against the first component 1 to hold the mechanism in position, except during the adjusting phase where the action of the horologist on the shaped portion 7 generates a force greater than that generated by the friction between the components 2-4-1.

The rotation of the second component 2 (relative to the first component 1) that is performed by a horologist using a suitable tool in the at least second shaped portions 7, causes the balls 4 to move radially along their respective first grooves 5. This movement changes the position of the bearing points at which the balls 4 press against the external circumferential surface 6 and causes axial translation (along the axis D) of the second component 2 relative to the first component 1 and to the movement blank 100. This axial translation allows micrometric adjustment of the endshake of the mobile unit.

The at least one first path 5 may make a non-zero angle, preferably comprised between 5° and 30°, relative to the direction that is orthoradial to the axis D. Consequently, the first paths may have a shape or a pathway that follows a spiral or a near-spiral relative to the axis D, for example the shape of an Archimedean spiral.

The first paths 5 and the second paths 3.1 may intersect at each of the interface elements 4. This may make it possible to ensure that the relative rotational movement of the first and second components leads to movement of the interface elements 4 with the movement having a radial component with respect to the axis D.

### Generalization

Although, in the particular embodiment described hereinabove, the mechanism comprises first paths or first grooves 5 formed on the first component 1, and second grooves or second paths 3.1 formed on a washer 3 that rotates as one with the second component 2, a mechanism can be proposed that comprises first paths or first grooves 5 formed on the second component 2 and second grooves or second paths 3.1 formed on the first component 1 and in particular on a washer 3 that rotates as one with the first component 1.

Effectively, according to the invention, the relative rotational movement about the axis D of the first paths or first grooves 5 and of the second grooves 3.1 advantageously allows the interface elements to move relative to the axis D in a plane P perpendicular or near-perpendicular to said axis D. In other words, the relative rotational movement about the axis D of the first paths or first grooves 5 and of the second grooves 3.1 allows the interface elements to move toward or away from the axis D. Thus, the component that comprises first paths or first grooves 5 is distinct from the component that comprises second grooves 3.1.

According to the embodiment described hereinabove, the translational movement of the second component 2 along the axis D relative to the first component 1 is made possible by virtue of a conical or frustoconical surface 6, intended to collaborate with interface elements, and arranged on the second component 2. According to an alternative embodiment, it would be conceivable to arrange this conical or frustoconical surface 6 on the first component 1. According to this particular alternative embodiment, the first paths or first grooves 5 could then be formed for example on a conical or frustoconical surface 6 of the first component 1.

Moreover, although in the particular embodiment described hereinabove the interface elements each take the form of a ball, it would also be conceivable for the interface elements to exhibit any other shape. By way of example, these interface elements could each take the form of a wheel or of a roller. More generally, the interface elements are rolling and/or sliding elements. To complement this, these interface elements could each comprise a frustoconical surface intended to drive a first component relative to a second component in translation along the axis D under the effect of a movement, for example a translational movement, of said interface elements in the plane P perpendicular or near-perpendicular to said axis D, particularly in a direction that is radial relative to the axis D, said interface elements being, for example, elastically returned by a return element that may or may not correspond to the return element 8.

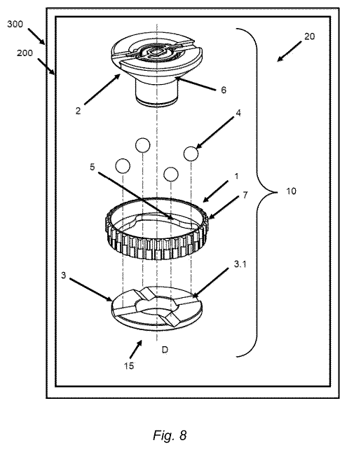

Although, in the embodiment described hereinabove, the interface elements are three in number, so as advantageously to form a regular polygon centered on the axis D, where each interface element is situated at a vertex of the polygon, it is conceivable to employ a different number of interface elements. Thus, alternatively, the system could comprise four interface elements, so as to form a square centered on the axis D, where each interface element is situated at a vertex of the square such as, for example, in the embodiment depicted in FIG. 8. Alternatively still, it would be conceivable to employ just two interface elements, notably in the scenario in which the interface elements induce linear contact rather than point contact with the first component 1 and/or the second component 2.

In the particular embodiment described hereinabove, provision is made for the second component 2, which is intended to receive or to form at least one bearing 15, to be rotationally driven about the axis D so as to cause said second component 2 to move translationally along the axis D. For this purpose, the second component 2 comprises at least second shaped portions 7 to allow it to be made to rotate about the axis D. According to an alternative embodiment, it would be conceivable to cause the first component 1 to rotate. Thus, according to this particular alternative embodiment, the first component 1 may comprise at least second shaped portions 7 to allow it to be made to rotate about the axis D. According to this particular alternative embodiment, the first component 1 may comprise the first paths or the first grooves 5. Advantageously, as depicted in FIG. 8, these first paths 5 may, in this particular scenario, take the form of cam surfaces of the first component 1 which extend in a direction parallel or near-parallel to the axis D. In this same particular scenario, the second component 2 may comprise the second grooves 3.1 and notably may comprise a washer 3 provided with second grooves, as well as the conical or frustoconical surface 6. In this particular alternative embodiment, the first component is able to rotate about the axis D relative to the case of the movement, while the second component is fixed in terms of rotation relative to the axis D but able to move translationally along the axis D.

Thus, depending on the embodiment, it is the second component or the first component that is able to be made to rotate about the axis D.

Whatever the embodiment, the second component intended to receive or to form a bearing is able to move translationally relative to the axis (D).

The invention also relates to a method for adjusting the endshake of a timepiece mobile unit. One way of executing such a method is described hereinafter and implements one of the adjusting-mechanism solutions described above.

The method comprises an action of moving one component in rotation about the axis D relative to the other component. In order to do this, the horologist may cause one component to rotate using at least second shaped portions 7 provided for this purpose and a suitable tool, such as a screwdriver, while the other component is immobilized on the rest of the movement, notably because the other component is fixed to a movement blank or because the other component is held stationary by the action of the horologist, notably using another tool. As a result of this relative rotational movement, as explained above, the component bearing the bearing, particularly the endstone jewel, moves axially (along the axis D). The result of this is that the axial endshake of the timepiece mobile unit 40 is modified.

Thus, by virtue of the solutions described hereinabove, the endshake adjusting mechanism allows a rotational movement of one component actuated by a horologist to be converted into an axial translational movement of a bearing via a movement-conversion device. The solutions advantageously exhibit interface elements 4 intended to collaborate with two elements 1, 2 that can be fitted one inside the other within an assembled bearing.

1. A mechanism for adjusting the endshake of a timepiece mobile unit for a timepiece, the mechanism comprising:
an axis,
a first component,
a second component intended to receive or to form at least one bearing,
interface elements collaborating with the first and second components,
a return element returning the first and second components into collaboration with the interface elements, and
at least first shaped portions of the first and second components which collaborate with the interface elements in order to move the interface elements relative to the axis in a plane perpendicular or near-perpendicular to the axis and thus move the second component translationally along the axis relative to the first component under the effect of a rotational movement about the axis of the first component or of the second component.

2. The mechanism as claimed in claim 1, wherein the interface elements are rolling and/or sliding elements.

3. The mechanism as claimed in claim 1, wherein the first component or the second component comprises at least second shaped portions to allow relative movement of the first component and of the second component in rotation about the axis.

4. The mechanism as claimed in claim 1, wherein the first component or the second component comprises, by way of first shaped portion, at least a first path specific to each interface element.

5. The mechanism as claimed in claim 4, wherein the at least one first path defines a pathway having a shape of a spiral around the axis, or a pathway that is substantially orthoradial with respect to the axis.

6. The mechanism as claimed in claim 4, wherein the first component or the second component, distinct from the component comprising the at least one first path, comprises, by way of first shaped portion, at least one second groove intended to collaborate with an interface element and extending in a direction that is radial or near-radial relative to the axis.

7. The mechanism as claimed in claim 6, wherein the at least one second groove is formed on a washer that rotates as one with the first component or the second component distinct from the component comprising the at least one first path.

8. The mechanism as claimed in claim 1, wherein the first component or the second component comprises, by way of first shaped portion, a conical or frustoconical surface intended to collaborate with the interface elements.

9. The mechanism as claimed in claim 1, wherein the first and second components fit one into the other, the second component notably fitting into the first component.

10. An assembled bearing comprising a mechanism as claimed in claim 1.

11. A mounted movement blank comprising a bearing as claimed in claim 10.

12. An assembly comprising:
a bearing,
a movement blank, and
a mechanism as claimed in claim 1 arranged at the interface between the bearing and the movement blank.

13. A timepiece movement comprising:
an assembly as claimed in claim 12,
and
a mobile unit.

14. A timepiece
comprising an assembly as claimed in claim 12.

15. A method for adjusting the endshake of a timepiece mobile unit of a timepiece movement as claimed in claim 13, the method comprising:
moving one component in rotation about the axis relative to the other component.

16. The mechanism as claimed in claim 1, wherein the at least one bearing is at least one damping bearing.

17. The mechanism as claimed in claim 2, wherein the rolling and/or sliding elements are balls.

18. The mechanism as claimed in claim 2, wherein the rolling and/or sliding elements are three or four rolling and/or sliding elements.

19. The mechanism as claimed in claim 2, wherein the rolling and/or sliding elements are three or four balls.

20. The mechanism as claimed in claim 4, wherein the at least one first path is at least a first groove intended to collaborate with an interface element.
